(19) United States
(12) Patent Application Publication
(10) Pub. No.: US 2007/0287512 A1
(43) Pub. Date: Dec. 13, 2007

(54) Layered mobile device

(76) Inventors: Pekka Kilpi, Helsinki (FI); Ilpo Kauhaniemi, Vantaa (FI); Esa-Sakari Maatta, Viiala (FI); Jussi Hakunti, Turku (FI); Anthony Dalby, Ealing London (GB)

Correspondence Address: PERMAN & GREEN, 425 POST ROAD, FAIRFIELD, CT, 06824, US

(21) Appl. No.: 11/450,880

(22) Filed: Jun. 9, 2006

(51) Int. Cl. H04B 1/08

(52) U.S. Cl. 455/575.1; 455/347

(57) ABSTRACT

A portable or mobile device includes a top layer, a middle layer, and a bottom layer that are slidably suspended from one another. The top layer can move between a retracted position in which a first keypad on the middle layer is covered and to a first extended position in which the first keypad is exposed. The top layer can also move to a second extended position in which a second keypad on the middle layer is exposed. The bottom layer can move between a retracted position in which a keypad on the bottom layer is covered and to an extended position in which a keyboard on the bottom layer is exposed.

### FIELD OF THE INVENTION

The aspects of the invention relates to portable or mobile devices having a housing including layers that are movable relative to one another to cover and expose a keypad.

### BACKGROUND OF THE INVENTION

A variety of layered mobile devices is known. The layers are often slidably and/or pivotably suspended from one another. The aim with these arrangements is to cover and expose a keypad. However, mobile devices, especially media devices, have a constantly increasing number of functionalities (phone, camera, media player, gaming, business use, etc.), each having specific requirements for the user interface, such as different input devices, e.g. keypads. Using the same input keys for all of the functionalities renders the use of the device complicated since too many functions are associated with each key. Thus, there is a need for a mobile device that provides additional user interface capacity for handling a myriad of functionalities in a user-friendly manner.

### DISCLOSURE OF THE INVENTION

On this background, one aspect of the invention to provide a mobile or portable device with an improved user interface for handling a large variety of different functionalities. A portable or mobile electronic device comprises a layered housing including a top layer, a middle layer and a bottom layer, the top layer being suspended from the middle layer for enabling the top layer to move relative to the middle layer between a first position and a second position, the bottom layer being suspended from the middle layer for enabling the bottom layer to move relative to the middle layer between a first position and a second position, at least one area of the upper surface of the middle layer being provided with elements of a user interface, at least one area of the upper surface of the bottom layer being provided with elements of a user interface, the top layer covering at least one portion of the area with user interface elements on the upper surface of the middle layer in the first position of the top layer and the top layer exposing the at least one portion of the area with user interface elements on the upper surface of the middle layer when the top layer is in the second position, and the middle layer covering at least one portion of the area with user interface elements on the upper surface of the bottom layer in the first position of the middle layer and the middle layer exposing the at least one portion of the area of with user interface elements on the upper surface of the bottom layer when the middle layer is in the second position.

By providing for the housing layers that can move relative to one another to expose different user interface elements it becomes possible to provide a small and compact device with dedicated user interfaces associated with different functionalities. Thus, it is possible to include a QWERTY type keyboard, a ITU-T type telephone keypad, a gaming pad and/or a multimedia player keypad in a single and compact device. Using a dedicated keypad for particular functionalities renders control of the device much easier for users, in particular the learning curve is shortened. Thereby, the acceptance of the technology is improved.

The top layer and the bottom layer can be slidably suspended from the middle layer.

Preferably, the sliding direction of the top layer is substantially transverse to the sliding direction of the bottom layer.

The area with user interface elements on the middle layer and the area with user interface elements on the bottom layer may include different specialized input devices. Preferably, these specialized input devices are specialized keyboards, such as a QWERTY type keyboard for entering text, a ITU-T for handling telephone calls and/or a gaming pad for playing games.

The upper surface of the middle layer may include a further area with user interface elements, in this case the top layer obscures both areas with user interface elements on the middle layer in the first position of the top layer relative to the middle layer and the top layer exposes the further area with user interface elements in a third position of the upper layer relative to the middle layer. Preferably, the further area with input user interface elements includes specialized input devices, such as specialized keyboards.

The device may further comprise a processor controlling the operation of the device, a sensor for detecting the position of the top layer relative to the middle layer, and a sensor for detecting the position of the bottom layer relative to the middle layer. In this case the sensors are coupled to the processor, and the processor is configured to change the operating mode of the terminal in response to a change in position of the top layer or the bottom layer.

The device may further comprise a display disposed on the upper surface of the top layer.

Another aspect of the invention provides a mobile device with improved configurability. A mobile device with a layered housing comprises a top layer, a middle layer and a bottom layer, the top layer being slidably suspended from the middle layer by a sliding mechanism with a first sliding direction, the bottom layer being slidably suspended from the middle layer by a sliding mechanism with a second sliding direction, and the first sliding direction being substantially transverse to the second sliding direction.

By providing the slidably connected layers with movements in different directions it becomes possible to add a greater variety of dedicated user interface elements to mobile devices.

Preferably, the top layer can slide relative to the middle layer between a retracted position in which it substantially completely overlaps with the middle layer and at least one extended position in which there is only a partial overlap between the top layer and the middle layer.

The bottom layer may slide relative to the middle layer between a retracted position in which it substantially completely overlaps with the middle layer and at least one extended position in which there is only a partial overlap between the bottom layer and the middle layer.

Further objects, features, advantages and properties of the device and mechanism according to the invention will become apparent from the detailed description.

### BRIEF DESCRIPTION OF THE DRAWINGS

In the following detailed portion of the present description, the invention will be explained in more detail with reference to the exemplary embodiments shown in the drawings, in which

FIG. 1 is a perspective view of a device according to an embodiment of the invention,

FIG. 2 is the same view as FIG. 1 with the device in another position,

FIG. 3 is a view on the side of the device as illustrated in FIG. 2,

FIG. 4 is a view on the front of the device as illustrated in FIG. 2,

FIG. 5 is a view on the top of the device as illustrated in FIG. 2,

FIG. 6 is the same view as FIG. 1 with the device in another position,

FIG. 7 is a view on the side of the device as illustrated in FIG. 6,

FIG. 8 is a view on the front of the device as illustrated in FIG. 6,

FIG. 9 is a view on the top of the device as illustrated in FIG. 6,

FIG. 10 is the same view as FIG. 1 with the device in another position,

FIG. 11 is a view on the side of the device as illustrated in FIG. 10,

FIG. 12 is a view on the front of the device as illustrated in FIG. 10,

FIG. 13 is a view on the top of the device as illustrated in FIG. 10,

FIG. 14 is a block diagram illustrating the general architecture of a device in accordance with the present invention,

FIGS. 15 to 20 are cut to open views of the sliding mechanism in the smart tablet of FIG. 1, and

FIGS. 21 to 23 are isometric views of a device according to a further embodiment of the invention.

### DETAILED DESCRIPTION OF PREFERRED EMBODIMENTS

In the following detailed description, the layered device according to the invention in the form of a smart tablet 1 will be described by the preferred embodiments

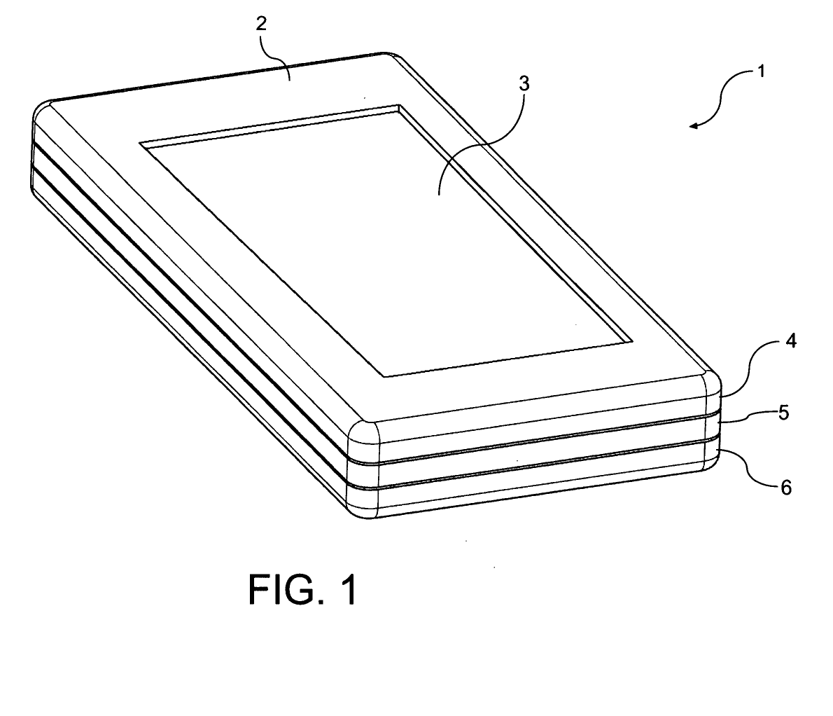

FIG. 1 illustrates the smart tablet 1 according to a preferred embodiment of the invention in a first position. The smart tablet 1 has a housing 2 that includes a top layer 4, a middle layer 5 and a layer 6. A touch sensitive display 3 is disposed in the upper surface of the top layer 4.

The three housing layers 4, 5, 6 are interconnected by a link mechanism that allows multiple degrees of freedom. The mechanism itself will be described in greater detail below.

The smart tablet 1 includes an on/off button (not shown), a speaker 55 (not visible in FIG. 1), and a microphone 56 (not visible in FIG. 1).

The smart tablet 1 can be used for a great variety of functionalities including use as a personal computer, use as a mobile phone, and use as a gaming terminal. The electronic components required for these functionalities will be described in greater detail below.

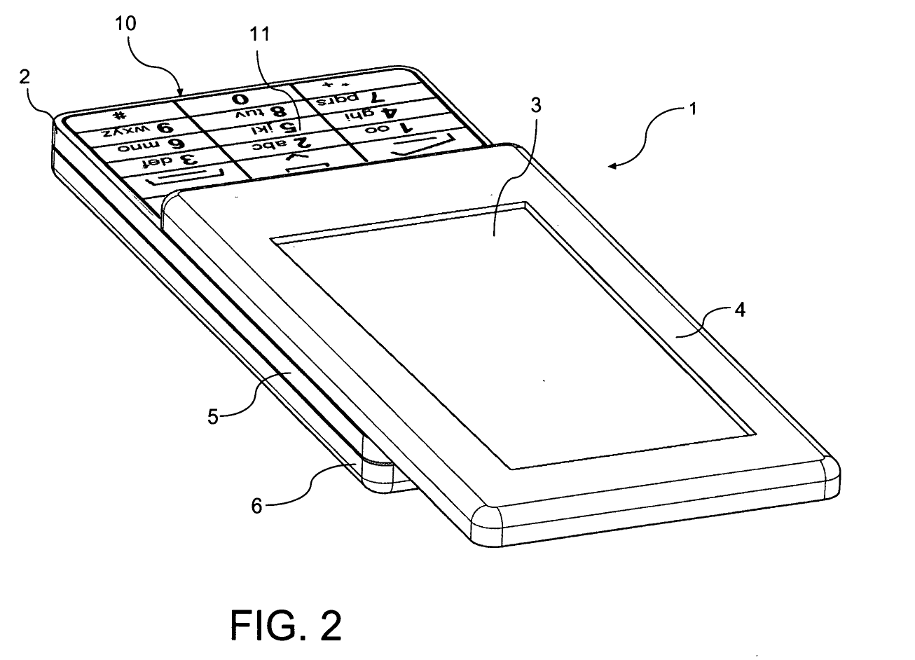

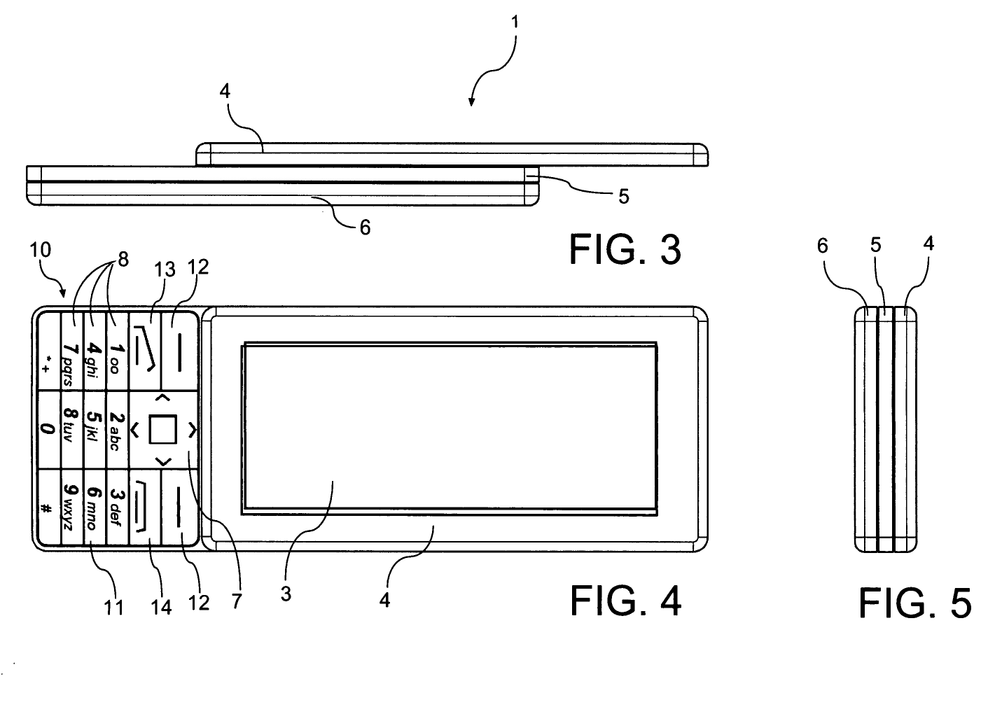

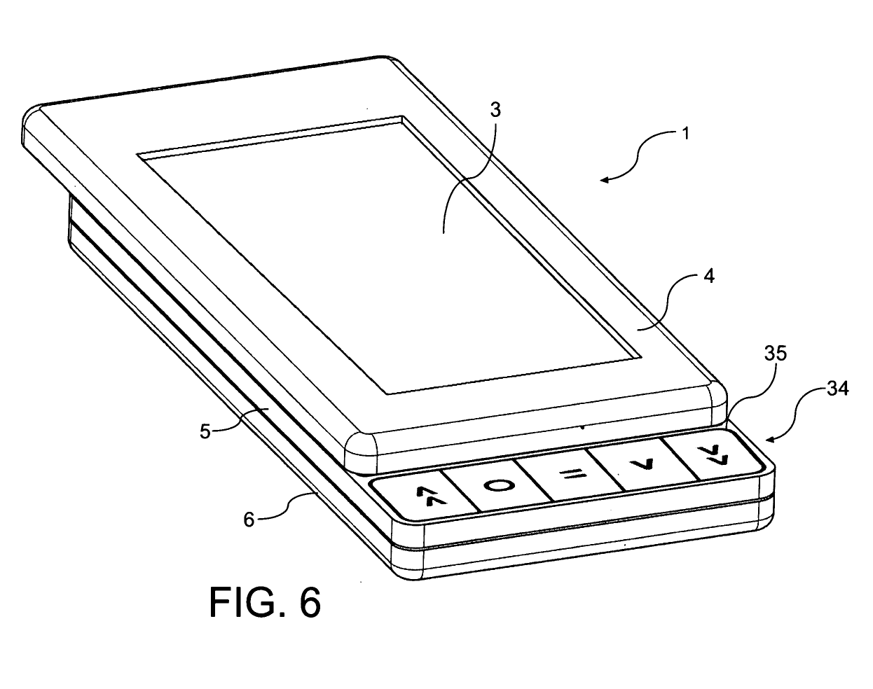

The link mechanism allows the top layer 4 to slide relative to the middle layer 5 in a direction parallel with the longitudinal axis of the elongated housing 2. FIG. 1 shows the top layer 4 in a retracted position in which the upper surface of the middle layer 5 is covered by the top layer 4. FIGS. 2, 3, 4 and 5 show the smart tablet 1 with the top layer 4 in a first extended position. The top layer 4 arrives in this position by a translative sliding movement from the retracted position along the longitudinal axis to the first extended position. In the first extended position of the top layer 4 a first area 10 of the upper surface of the middle layer 5 is exposed. The first area 10 is provided with user interface elements. In the present embodiment the user interface elements include a UTI-T style keypad 11 that includes a first group of keys including a plurality of alphanumerical keys 8 and a second group of keys including call handling keys.

With the alphanumeric keys 8 the user can enter a telephone number, write a text message (SMS), write a name (associated with the phone number), etc. Each of the twelve alphanumeric keys 8 is provided with a figure “0-9” or a sign “#” or “*”, respectively. In alpha mode each key is associated with a number of letters and special signs used in the text editing.

The second group of keys includes two softkeys 12, two call handling keys (off-hook key 13 and on-hook key 14), and a 5-way navigation key 7 (up, down, left, right and center: select/activate). The function of the softkeys 12 depends on the state of the smart tablet 1, and navigation in the menu is performed by using the navigation-key 7. The present function of the softkeys 12 is shown in separate fields (soft labels) in a dedicated area of the display 3, just above the softkeys 12. The two call handling keys 13, 14 are used for establishing a call or a conference call, terminating a call or rejecting an incoming call.

The navigation key 7 is a four- or five-way key which can be used for cursor movement, scrolling and selecting (five-way key) and is placed centrally on the front surface of the phone between the display 3 and the group of alphanumeric keys 8.

The telephone functionality of the smart tablet 1 is adapted for communication via a cellular network, such as the GSM 900/1800 MHz network, but could just as well be adapted for use with a Code Division Multiple Access (CDMA) network, a 3G network, or a TCP/IP-based network to cover a possible VoIP-network (e.g. via WLAN, WIMAX or similar) or a mix of VoIP and cellular such as UMA (Universal Mobile Access).

The telephone functionality can be automatically activated when the top layer 4 is slid from the retracted position shown in FIG. 1 to the first extended position shown in FIG. 2 and vice versa. Further, the orientation of the information on the display 3 is adapted to align correctly with keypad 11 when the latter is exposed. This automatic activation and deactivation can be user selectable. Thus, sliding the top layer 4 to the first extended position transforms the multipurpose smart tablet 1 into a device than can be considered as having the characteristics of a dedicated mobile phone.

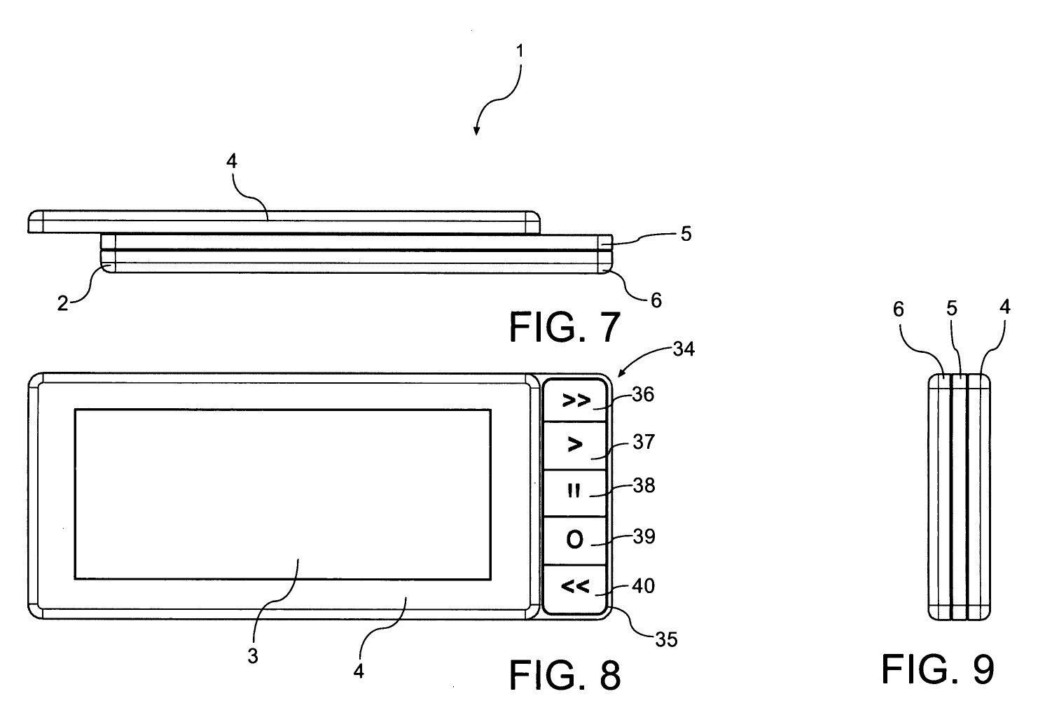

FIGS. 6, 7, 8 and 9 show the smart tablet 1 with the top layer 4 in a second extended position. The top layer 4 arrives in the second extended position by a sliding movement from the retracted position in the opposite direction as compared to the sliding movement to arrive at the first extended position from the retracted position. In the second extended position a second area 34 of the upper surface of the middle layer 5 is exposed. The second area 34 includes elements of a user interface. The present embodiment of these elements includes a keypad 35 for controlling a multimedia player. The keypad 35 includes a fast-forward key 36, a play key 37, a pause key 38, a stop key 39 and a fast rewind key 40. These keys, with or without a combination with a touch screen version of the display 3, enable the user to select and play digital music, video or other media stored in a memory of the smart tablet 1. When the upper layer 4 is moved from the retracted position to the second extended position in the smart tablet the latter automatically changes to a multimedia player mode, in which a multimedia player is started and in which the information shown on the display relates to handling multimedia. Further, the processor 18 ensures that the orientation of the information on the display 3 is aligned with the orientation of the keypad 35. Thus, sliding the top layer 4 to the second extended position transforms the multipurpose smart tablet 1 into a device that can be considered as having the characteristics of a dedicated multimedia player. When the top layer is returned to the retracted position, the multimedia player continues in the background. However, the user controllable device settings allow a different configuration in which the multimedia player is not automatically activated when the top layer 4 is moved to the second extended position or in which the music player is deactivated when the top layer 4 is moved from the second extended position to the retracted position. The orientation of information on the display may also return to its previous state when the multimedia keyboard 35 is covered. Also this automatic step can be controlled by user settings.

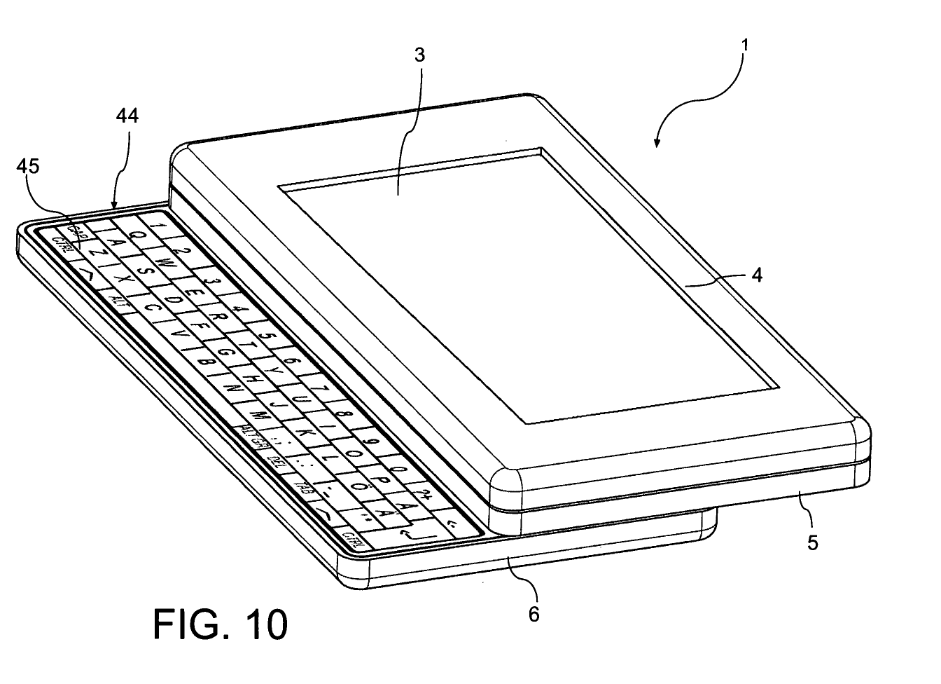

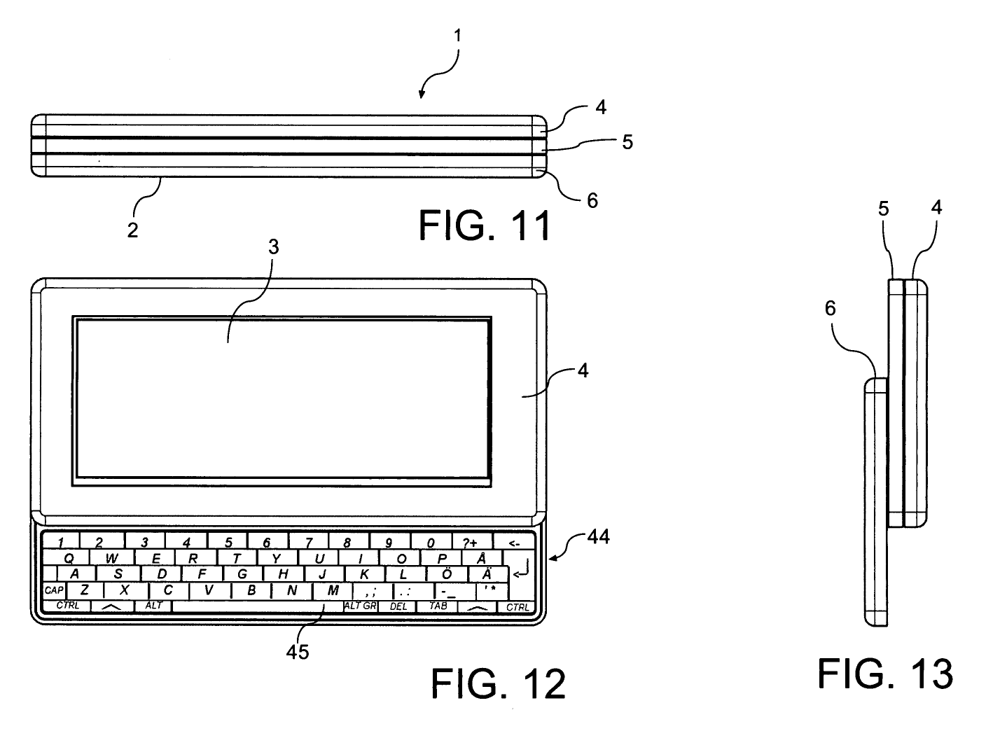

FIGS. 10, 11, 12 and 13 show the smart tablet 1 with the top layer 4 in the retracted position and the bottom layer 6 in an extended position. The bottom layer 6 arrives in the extended position by a sliding movement from the retracted position of the bottom layer 6 to the extended position. The sliding movement of the bottom layer 6 relative to the middle layer 5 is substantially transverse to the sliding direction of the upper layer relative to the middle layer 5. In the extended position of the bottom layer 6 an area 44 at of the upper surface of the bottom layer 6 is exposed. The exposed area 44 includes user interface elements. In the present embodiment of the invention the user interface elements include a QWERTY type keyboard 45. The keyboard 45 is particularly suitable for entering text, such as for example in word processing. When the bottom layer 6 is moved to the extended position the smart tablet 1 assumes a personal computing mode which is particularly adapted for running computer applications that are typical for personal computers, such as word processing, spreadsheets, e-mail clients, Internet browsers, etc. In this mode of the smart tablet 1 the information on the display 3 has a landscape orientation so that it is aligned with the orientation of the keyboard 45.

Thus, sliding the bottom layer 4 to the extended position transforms the multipurpose smart tablet 1 into a device than can be considered as having the characteristics of a mini personal computer.

The mechanism linking the top layer 4 to the middle layer 5 and the bottom layer 6 to the middle layer 5 is configured to allow only the top layer or only the bottom layer to assume an extended position, i.e. the mechanism obstructs a simultaneous extended position for the top layer 4 and the bottom layer 6.

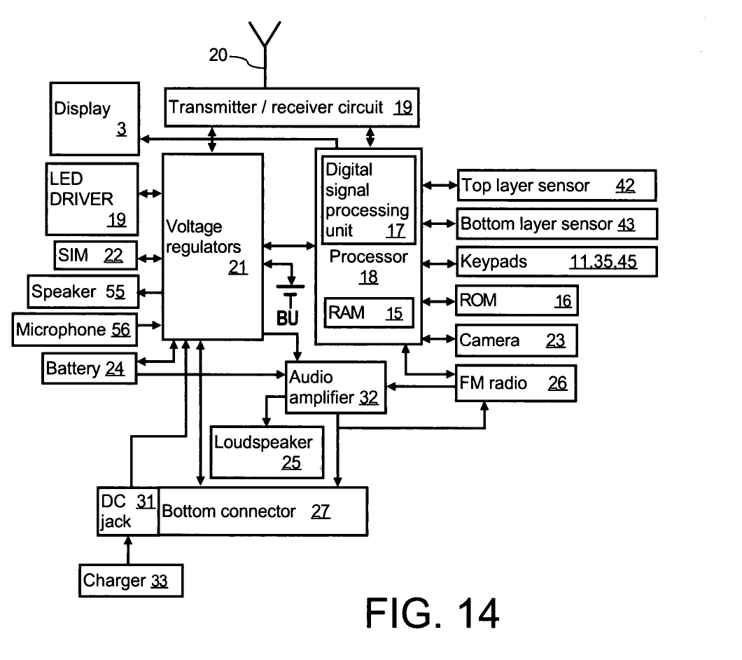

FIG. 14 illustrates in block diagram form the general architecture of a smart tablet 1 constructed in accordance with an embodiment of the present invention. The processor 18 controls the operation of the device and has an integrated digital signal processor 17 and an integrated RAM 15. The processor 18 controls the communication with the cellular network via the transmitter/receiver circuit 19 and an internal antenna 20. A microphone 56 coupled to the processor 18 via voltage regulators 21 transforms the user's speech into analogue signals. The analogue signals formed thereby are A/D converted in an A/D converter (not shown) before the speech is encoded in the DSP 17 that is included in the processor 18. The encoded speech signal is transferred to the processor 18, which e.g. supports the GSM terminal software. The digital signal-processing unit 17 speech-decodes the signal which is transferred from the processor 18 to the speaker 55 via a D/A converter (not shown).

The voltage regulators 21 form the interface for the speaker 55, the microphone 56, the LED drivers 19 (for the LEDS backlighting the keypads 11, 35, 45 and the display 3), the SIM card 22, battery 24, the bottom connector 27, the DC jack 31 (for connecting to the charger 33) and the audio amplifier 32 that drives the (hands-free) loudspeaker 25.

The processor 18 also forms the interface for some of the peripheral units of the device, including a Flash ROM memory 16, the graphical display 3, the keypads 11, 18, 24, a top layer sensor 42, a bottom layer sensor 43, a camera 23 and an FM radio 26.

The top layer sensor 42 detects the actual position of the top layer 4 relative to the middle layer 5. The bottom layer sensor 43 detects the actual position of the bottom layer 6 relative to the middle layer 5. The tablet software instructs the processor 18 to assume an appropriate state of the tablet in accordance with the information from the top layer sensor 42, and the bottom layer sensor 43. The state of the tablet is not only determined on the basis of the sensors 42 and 43, but also on events, such as incoming telephone calls, entry of data by means of the keyboards, change in battery status, change in antenna signal strength, etc.

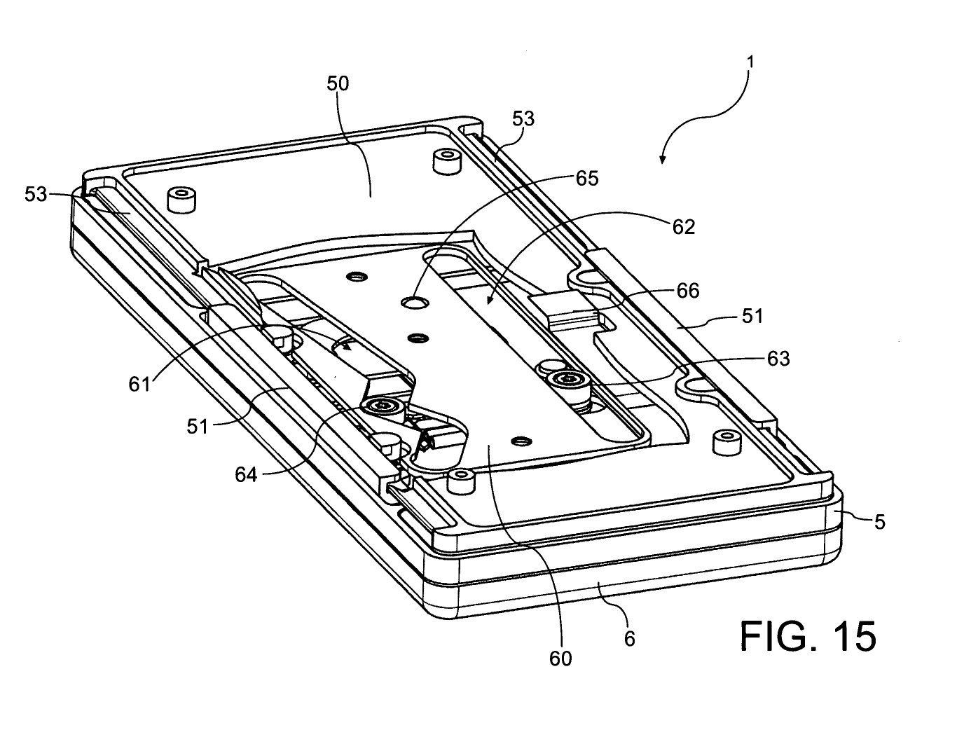

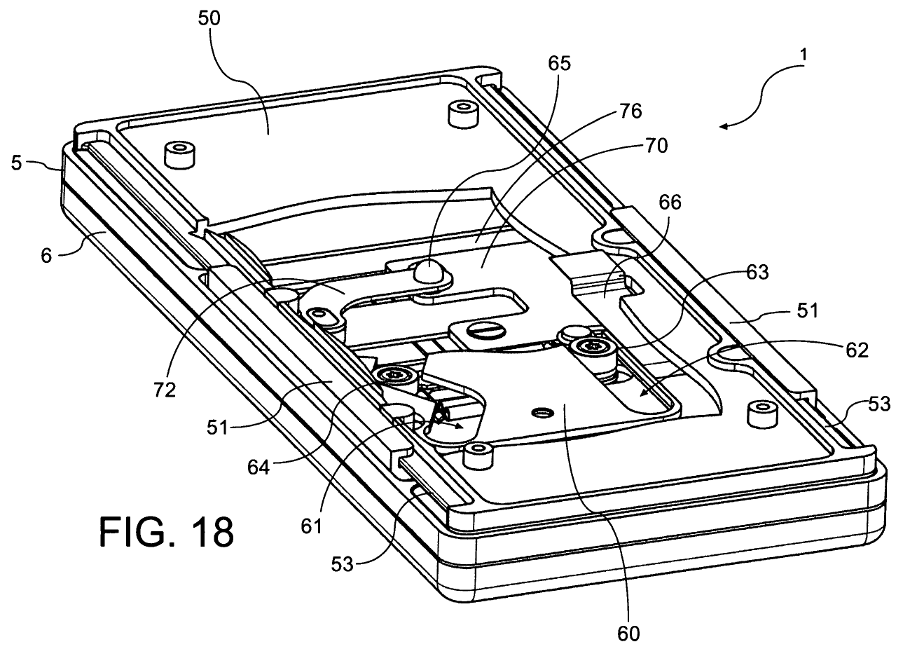

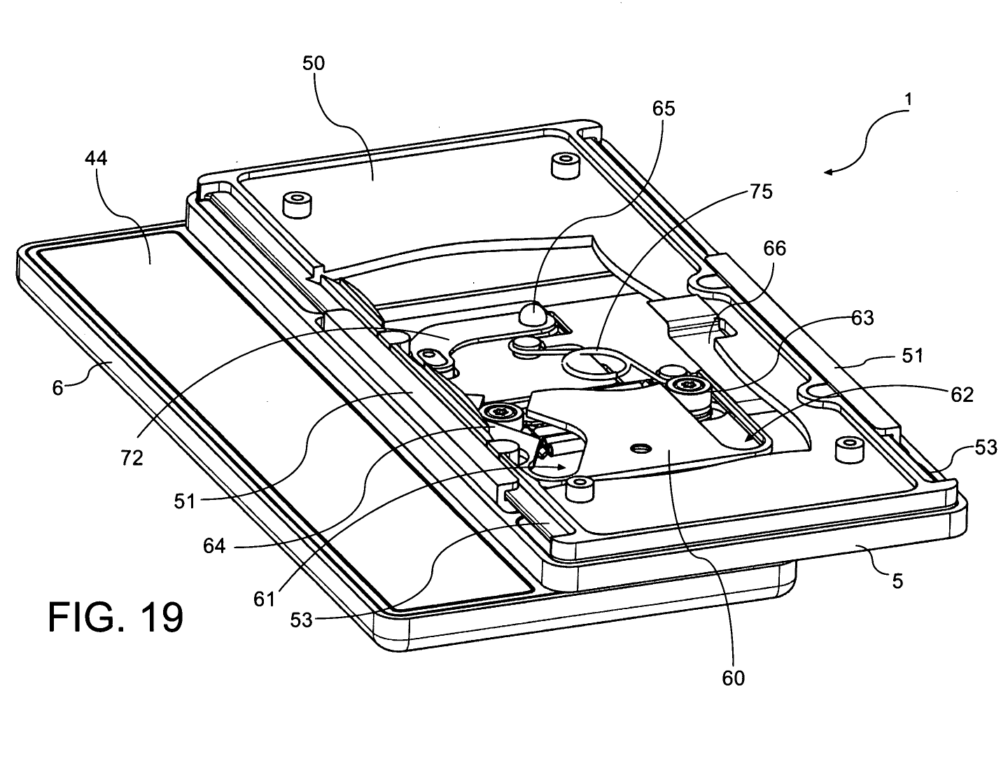

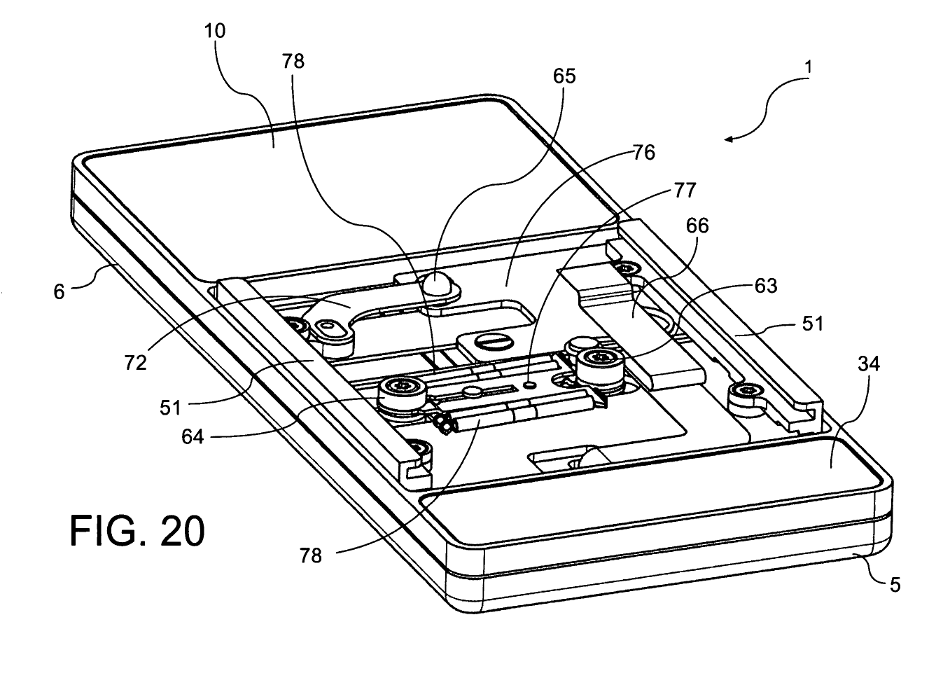

FIGS. 15 to 20 illustrate the sliding mechanism that suspends the top layer 4 and the bottom layer 6 from the middle layer 5 by means of cut open views in which some of the elements of the smart tablet 1 have been removed for illustrative purposes.

The sliding mechanism includes a display support frame 50 that is provided with parallel guide rails 53 extending along its long sides. The guide rails 53 engage two oppositely disposed U-shaped guide tracks 51 that are protruding from the middle layer 5. The top layer 4 with the display 3 therein is mounted on the display support frame 50.

The display support frame 50 is connected to a guide plate 60. The guide plate 60 is provided with a meandering slot 61 and a rectilinear slot 62. A guide wheel 63 connected to the middle layer 5 is received in the rectilinear slot 62. A guide wheel 64 is received in the meandering slot 61. A locking ball 65 can lock the guide plate 60 in the retracted position of the top layer 4. A flexible printed circuit 66 connects the display 3 to a printed circuit board (not shown) in the middle layer 5.

Below the guide plate 60 a link member 72 engages the locking ball 65. A guideway plate 70 connects the bottom layer 6 to the middle layer 5. A bi-stable spring 75 is connected with one of its ends to the middle layer 5 and with another of its ends to the guideway plate 70 that moves in unison with the bottom layer 6. The guideway plate 70 is disposed between two transverse ledges 76 (only one of them can be seen in the drawings) that are a part of the middle layer 5 and give the guideway plate 70 directional stability. The bi-stable spring 75 urges the bottom layer 6 in the closing direction during the first part of the sliding movement from the retracted position of the bottom layer to the extended position of the bottom layer and urges the bottom layer 6 in the opening direction during the last part of the sliding movement from the retracted position of the bottom layer to the extended position of the bottom layer.

Guide wheel 64 is transversely suspended by a guide channel 77 from the middle layer 5 and urged by tension springs 78 towards guide wheel 63.

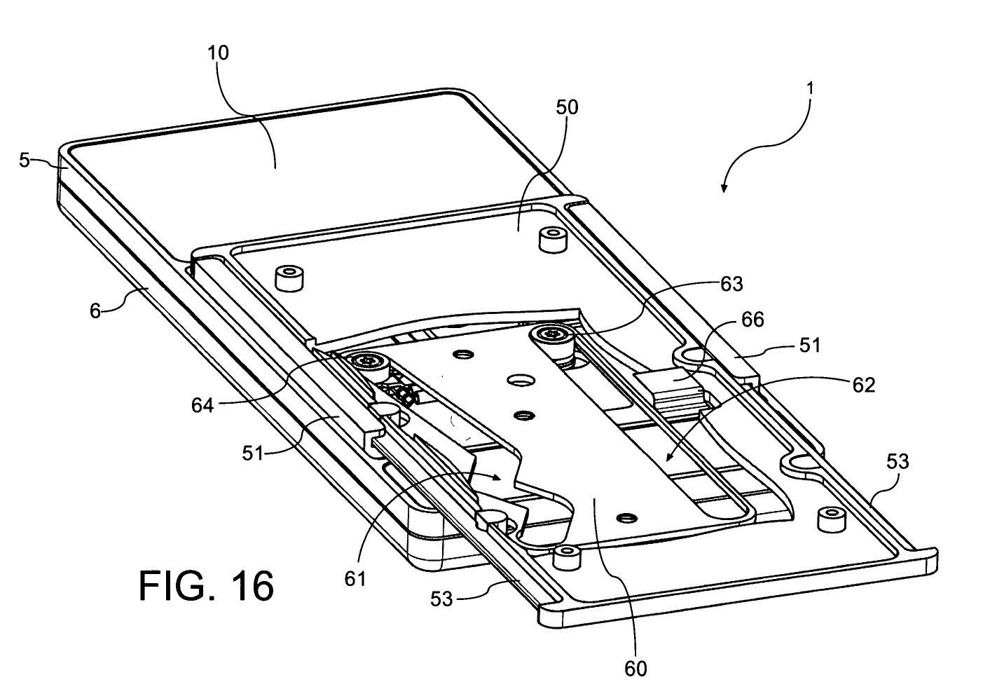

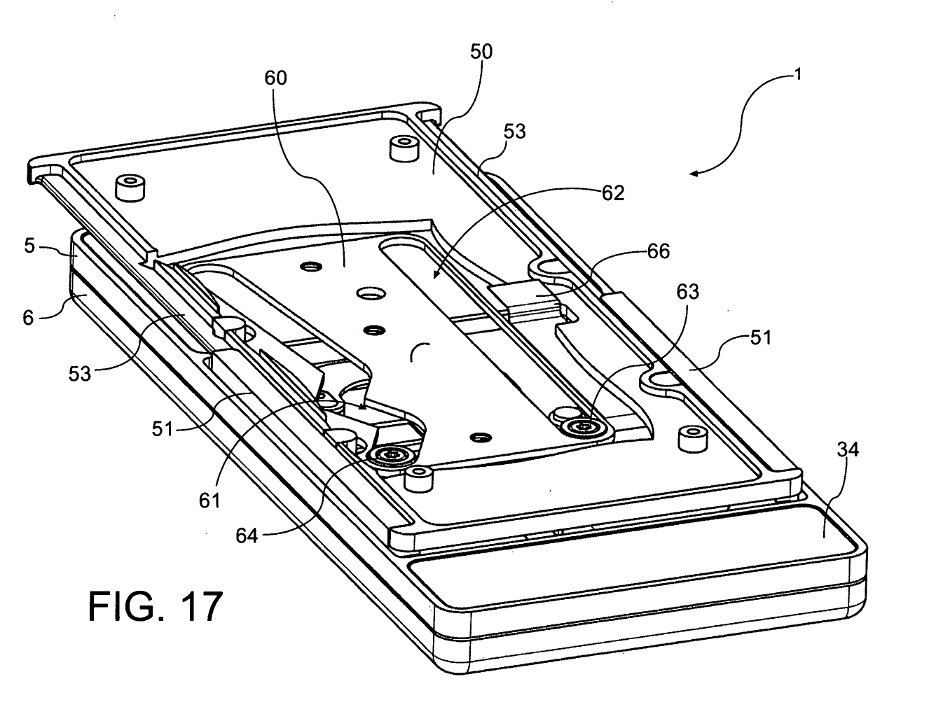

In FIG. 15 the top layer 4 and the bottom layer 6 are in the retracted position. In operation, the guide plate 60 urges the looking ball 65 downwards when it is moved to either of its extended positions (FIGS. 16 and 17). The downwardly urged locking ball 65 is then received in a recess in the base plate 70, thereby preventing any relative movement between the link plate 72 and the base plate 70, thus locking the bottom layer 6 in the retracted position. When the bottom layer 6 is moved to its extended position it urges the locking ball in an upward direction. The locking ball thereby engages a recess in the guide plate 60 and locks the upper layer 4 in the retracted position.

The resiliently urged guide wheel 64 in interaction with the meandering slot 61 creates a bi-stable opening and closing force from the retracted position of the top layer 4 to both the first extended position and the second extended position of the top layer 4. Thus, the top layer 4 is urged towards the retracted position during the first portion of its movement towards either of the extended positions, and the top layer 4 is urged towards either of the extended positions during the last portion of its movement towards the extended positions.

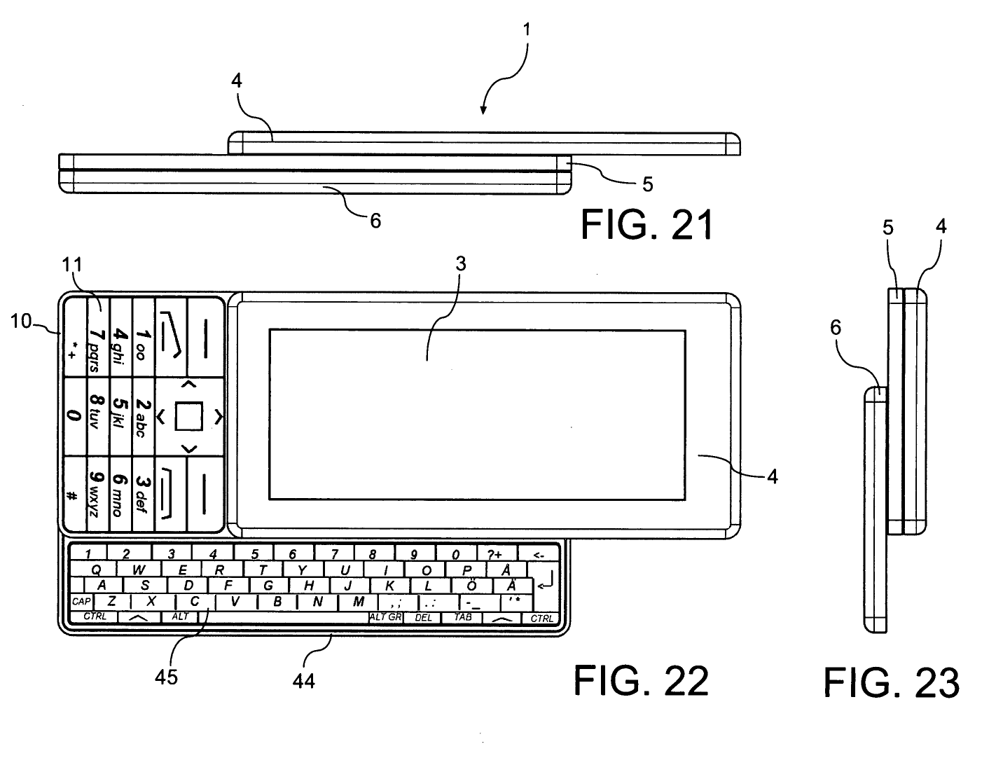

FIGS. 21-23 illustrate another embodiment of the device according to the present invention. This embodiment is substantially identical to the embodiment described above; however the smart tablet 1 does not include a locking and biasing mechanism, thereby keeping the linking mechanism simpler. This configuration allows the user to simultaneously use two different keypads.

The second embodiment does include guide rails and guide tracks and/or guideway plates (not shown) for enabling a slidable suspension between the bottom layer 6 and the middle layer 5 as well as between the top layer 4 and the middle layer 5. Further, snap or (bi-stable) spring means (not shown) are provided to ensure stable retracted and extended positions. In this employment the top layer 4 and the bottom layer 6 can be simultaneously moved to the extended positions, so the user can simultaneously make use of two different keyboards.

The embodiments above have been described with particular keypads in the areas that can be covered and exposed. However, it should be understood that other types of user interface elements, in particular input devices can be used. For example the area 10 can be provided with a touchpad, the area 44 can be provided with a “piano” style keyboard, and the area 34 can be provided with gaming controls such as joysticks or other navigational input devices. It is also possible to provide the areas 10, 34, 44 with displays.

The exposable areas (not shown) on the rear side of the top layer 4 and the middle layer 5 can be provided with additional displays, with photo and/or video camera lenses, infrared transmitters or user interface elements such as keys, keypads and/or navigation devices.

The term “comprising”as used in the claims does not exclude other elements or steps. The term “a” or “an” as used in the claims does not exclude a plurality. The single processor or other unit may fulfill the functions of several means recited in the claims.

The reference signs used in the claims shall not be construed as limiting the scope.

Although the present invention has been described in detail for purpose of illustration, it is understood that such detail is solely for that purpose, and variations can be made therein by those skilled in the art without departing from the scope of the invention.

1. A device comprising:
a layered housing including a top layer, a middle layer and a bottom layer,
said top layer being suspended from said middle layer for enabling the top layer to move relative to the middle layer between a first position and a second position,
said bottom layer being suspended from said middle layer for enabling the bottom layer to move relative to the middle layer between a first position and a second position,
at least one area of an upper surface of the middle layer being provided with elements of a user interface,
at least one area of an upper surface of the bottom layer being provided with elements of a user interface,
said top layer covering at least one portion of said area with user interface elements on the upper surface of the middle layer in said first position of the top layer and said top layer exposing said at least one portion of said area with user interface elements on the upper surface of the middle layer when the top layer is in said second position, and
said middle layer covering at least one portion of said area with user interface elements on the upper surface of the bottom layer in said first position of the middle layer and said middle layer exposing said at least one portion of said area with user interface elements on the upper surface of the bottom layer when the middle layer is in said second position.

2. A device according to claim 1, wherein the top layer, the middle layer and the bottom layer remain substantially aligned in said first and second positions.

3. A device according to claim 1, wherein said top layer is slidably suspended from said middle layer.

4. A device according to claim 3, wherein said bottom layer is slidably suspended from said middle layer.

5. A device according to claim 4, wherein the sliding direction of the top layer is substantially transverse to the sliding direction of the bottom layer.

6. A device according to claim 1, wherein said area with user interface elements on said middle layer includes specialized input devices, and said area with user interface elements on said bottom layer includes specialized input devices.

7. A device according to claim 6, wherein said specialized input devices include specialized keyboards.

8. A device according to claim 1, wherein said upper surface of the middle layer includes a further area with user interface elements, said top layer covering both areas with user interface elements on said middle layer in said first position of said top layer relative to the middle layer and said top layer exposing said further area with user interface elements in a third position of said upper layer relative to said the middle layer.

9. A device according to claim 8, wherein said further area with input user interface elements includes specialized input devices.

10. A device according to claim 9, wherein said specialized input devices in said further area include specialized keyboards.

11. A device according to claim 1, wherein said upper surface of the bottom layer includes a further area with user interface elements, said middle layer covering both areas with user interface elements on said bottom layer in said first position of said middle layer relative to the bottom layer and said middle layer exposing said further area with user interface elements in a third position of said middle layer relative to said bottom layer.

12. A device according to claim 1, further comprising a processor controlling the operation of the device, a sensor for detecting the position of the top layer relative to the middle layer, a sensor for detecting the position of the bottom layer relative to the middle layer, wherein said sensors are coupled to the processor and the processor is configured to change the operating mode of the terminal in response to a change in position of the top layer or to the bottom layer.

13. A device according to claim 1, further comprising a display in the upper surface of the top layer.

14. A device according to claim 1, further comprising a mechanism for avoiding that an area with user interface elements on the middle layer is exposed simultaneously with an area with user interface elements on the bottom layer.

15. A device according to claim 1, wherein the device is a mobile phone.

16. The device according to claim 1 where the device is a portable or mobile device.

17. A mobile device with a layered housing that comprises:
a top layer, a middle layer and a bottom layer,
said top layer being slidably suspended from said middle layer by a sliding mechanism with a first sliding direction,
said bottom layer being slidably suspended from said middle layer by a sliding mechanism with a second sliding direction, and
said first sliding direction being substantially transverse to said second sliding direction.

18. A mobile device according to claim 17, wherein said top layer can slide relative to the middle layer between a retracted position in which it substantially completely overlaps with said middle layer and at least one extended position in which there is only a partial overlap between the top layer and the middle layer.

19. A mobile device according to claim 17, wherein said bottom layer can slide relative to the middle layer between a retracted position in which it substantially completely overlaps with said middle layer and at least one extended position in which there is only a partial overlap between the bottom layer and the middle layer.

20. A mobile device according to claim 17, wherein the mobile device is a mobile phone.
